(19) United States
(12) Patent Application Publication
(10) Pub. No.: US 2026/0048537 A1
(43) Pub. Date: Feb. 19, 2026

(54) PLASTIC INJECTION MOLD FOR THE MANUFACTURE OF A FLUID-SAVING DEVICE

(71) Applicant: Water Saver Tech LLC, Dover, DE (US)

(72) Inventor: Yarib Soto Arellano, Tijuana (MX)

(73) Assignee: Water Saver Tech LLC, Dover, DE (US)

(21) Appl. No.: 19/296,243

(22) Filed: Aug. 11, 2025

(30) Foreign Application Priority Data
Aug. 13, 2024 (MX) MX/U/2024/000337

(51) Int. Cl. B29C 45/04; B29C 45/27; B29C 45/36; B29C 45/40

(52) U.S. Cl. CPC B29C 45/0416; B29C 45/27; B29C 45/401; B29C 2045/2759; B29C 45/36

(57) ABSTRACT

A plastic injection mold for the manufacture of fluid-saving devices is disclosed. The mold includes two subassemblies called the fixed part (Side A) and the moving part (Side B). When they are assembled together, these two subassemblies form the mold. When used in a plastic (polymer) injection process, the mold allows for mass production of a fluid-saving device.

The mold is composed of steel plates superimposed on one another, aligned and joined by fastening elements arranged between the plates. The main elements are the cavity, the core, and the forming pins. The forming pins are interchangeable to achieve product flexibility and obtain different models of fluid-saving devices.

### FIELD OF THE DISCLOSURE

The present invention relates to injection molds, particularly to plastic injection molds for the manufacture of fluid-saving devices, where the mold is a so-called two-plate mold.

### BACKGROUND OF THE DISCLOSURE

Injection molding is a process that involves the injection of materials, preferably plastic resins (or plastics), that have been previously melted by heat and subsequently injected into a mold of a desired design and size, where they cool and solidify, acquiring the design characteristics of the desired part. Furthermore, injection molding has enabled mass production and product standardization and has therefore been used in a wide range of industries that manufacture plastic products.

Injection molding conditions, such as pressure and temperature, are variables that contribute to the precision and quality of the final molded product. The mold is one of the most important tools in the molding process for producing plastic parts with the desired shape. Currently, molds can be made from different materials, such as tempered steel, pre-tempered steel, aluminum, or various alloys, such as beryllium copper. These materials receive special treatments depending on their intended use and wear resistance, which will affect their lifespan. When choosing the type of material to use in mold manufacturing, one must consider cost, use, heat dissipation speed, and which materials offer greater or lesser heat dissipation.

The classification of injection molds is governed by their main characteristics, construction, and function. DIN E-16750 standard for plastic injection molds contains the following classification:
Standard mold (two-plate mold).
Jaw mold (sliding mold).
Segmental extraction mold.
Three-plate mold.
Deck mold (sandwich mold).
Hot-runner mold.

This classification is very general, as mold configurations vary greatly depending on component or production requirements. Of all the configurations, two-and three-plate designs are the easiest to recognize and also the most commonly used. The two-and three-plate design names are due to the number of parting lines used in the design. (Molde para Inyección de Piezas de Plástico—Escuela de Ingeniería de Bilbao [Plastic Injection Mold-Bilbao School of Engineering]-Mikel Gonzalez Esteban—Jun. 18, 2018).

The mold (unclaimed/described) used in U.S. Pat. No. 6,698,455 for the manufacture of the multi-fluid saving device is a simple two-platen cold-runner plastic injection mold consisting of a block of cavities 1 and 2 with an ejector pin system per cavity. This mold design is limited to the manufacture of solid plastic cylinders, producing a semi-finished product that subsequently undergoes a second central drilling or boring process, which drills the resulting product, i.e., the multi-fluid saving device, piece by piece. Furthermore, it involves high plastic resin consumption and labor to remove excess or burrs, which increases manufacturing costs for the multi-fluid saving device. Productivity is also affected by the drilling process once the product is ejected from the mold.

Therefore, there is a need for a plastic injection mold for manufacturing a fluid-saving device that eliminates secondary manufacturing processes such as drilling the part once it is obtained/ejected from the mold, allows for lower resin consumption and increased productivity, resulting in savings in manufacturing costs.

Therefore, in order to achieve the stated objective, it was necessary to design a mold that, in addition to the elements known to date, included a block of cavities, a core block, fixed forming pins, ejector sleeves, among others, which is far superior to any mold of the prior art.

### BRIEF DESCRIPTION OF THE DISCLOSURE

The main objective of the invention is to provide a plastic injection mold for the manufacture of a fluid-saving device (also referred to as a plastic part for practical purposes) that eliminates secondary manufacturing processes, allows for lower resin consumption, and increases productivity, i.e., reduces the manufacturing costs of the device.

To achieve this, the present invention provides a plastic injection mold for the manufacture of a fluid-saving device comprising two subassemblies, hereinafter referred to as the fixed part (Side A) and the moving part (Side B), formed by an integration of mechanical elements that provide a significant change in the manufacturing method of the plastic part. This change consists of mechanically connecting forming pins and ejector sleeves to the core block of the mold. The forming pins form the hole in the plastic part and determine its internal diameter, which in turn determines or controls the resulting flow rate.

The plastic injection mold for the manufacture of a fluid-saving device comprises: a locating ring mounted and screwed onto a cavity backing plate to center the nozzle of the barrel of the injection unit with a flow channel sprue of the mold through which the molten resin flows into the internal channels or conduits of the mold, the cavity backing plate is coupled and serves as a support to fix or hold a cavity holder plate and so that also the fixed part or Side A of the mold can be fastened to the platen of the injection machine in addition to also providing support for fixing the flow channel sprue, which in turn is mounted or fixed to the locating ring; 4 guide bolts located between the cavity backing plate and a cavity holder plate, the cavity holder plate into which the guide bolts are introduced by means of corresponding boreholes or holes, connects or couples with the flow channel sprue; 4 centering bushings to allow 4 fixed forming bolts to align to perform the hermetic sealing of Side A and Side B of the mold; a block with cavities that receives the flow of plastic resin to define the external geometry of the final product or plastic part; a core block or internal block which defines a part of the internal geometry of the fluid-saving device and where channels or conduits are located through which the molten plastic resin flows; a movable core or internal block holder plate, where the core or internal block with cavities is coupled or located; 4 guide bushings that are used to align and assemble the core holder plate and a core backing plate; the movable backing plate or core fixing support provides support to the core or internal holder plate to allow it to be attached to the injection machine platen; 2 aligning bolts that keep all the elements aligned during mold assembly; an ejector plate which has holes to prevent or avoid the movement of ejector sleeves and ejector retaining bolts; the ejector sleeves allow the molded plastic part (fluid-saving device) to be released from 4 fixed forming bolts and the finished product to be ejected; a sprue extractor pin that holds or clamps the molded plastic part from the moment of plastic resin casting and separates the finished plastic part from the fixed side when the mold is opened; 4 ejector retainer pins that limit the stroke of the ejector sleeves; an ejector backing plate to retain or hold the ejector retainer pins and the ejector sleeves in the assembled position; 4 forming pins which provide the geometry of the central hole of the internal body of the 4 fluid saving devices that are manufactured; 2 support pillars to generate a space or gap to allow the ejector plate, the ejector backing plate and ejector sleeves, which together form an ejection system, to move forward pushing the sleeves forward, protruding from the core or internal block and ejecting the plastic pieces; 4 ejection limiting pins which limit the contact between the ejection backing plate and an anchor support plate that holds the moving part (Side B) of the mold so that it can be attached to the injection machine platen.

### BRIEF DESCRIPTION OF THE DRAWINGS

The accompanying drawings, which are incorporated into and constitute part of this description, should be interpreted in conjunction with said description, although a person skilled in the art should understand the principles and embodiments disclosed on their own.

Some aspects of the disclosure can be implemented in relation to the embodiments illustrated in the accompanying drawings. The accompanying drawings illustrate different aspects of the present invention, and, where appropriate, reference numerals illustrating similar structures, components, materials, and/or elements in the different figures should correspond similarly. In light of the drawings, a person skilled in the art will understand that various couplings or unions of the structures, components, and/or elements, equivalent or different from those specifically shown, are contemplated and fall within the scope of the present invention.

This disclosure is not limited to any individual aspect or embodiment of the described invention, nor is it limited to combinations and/or permutations of such aspects and/or embodiments. In particular, an embodiment or implementation described herein should not be construed as preferred or advantageous, but rather merely reflects or demonstrates that the embodiments are exemplary embodiments.

FIG. 1 shows cross-sectional views (A and B) of the plastic injection mold for manufacturing a fluid-saving device of the prior art.

FIG. 2 shows cross-sectional views (A and B) of the plastic injection mold for manufacturing a fluid-saving device of the present invention.

FIG. 3 is an isometric view of the plastic injection mold showing its two subassemblies: the fixed part (Side A) and the moving part (Side B).

FIG. 4 is a detailed exploded view of the plastic injection mold of the present invention.

FIG. 5 is a view of the locating ring of the plastic injection mold of the present invention.

FIG. 6 is a view of the flow channel sprue of the plastic injection mold of the present invention.

FIG. 7 is a view of the cavity backing plate of the plastic injection mold of the present invention.

FIG. 8 is a view of the guide pins of the plastic injection mold of the present invention.

FIG. 9 is a perspective view of the cavity holder plate of the plastic injection mold of the present invention.

FIG. 10 is a view of the centering bushings of the plastic injection mold of the present invention.

FIG. 11 is a view of the block of cavities used in the plastic injection mold of the present invention.

FIG. 12 is a view of the core or internal block of the plastic injection mold of the present invention.

FIG. 13 is a view of the core holder plate of the plastic injection mold of the present invention.

FIG. 14 is a view of the guide bushings of the plastic injection mold of the present invention.

FIG. 15 is a view of the core backing plate of the plastic injection mold of the present invention.

FIG. 16 is a view of the alignment pins used in the plastic injection mold of the present invention.

FIG. 17 is a view of the ejector plate of the plastic injection mold of the present invention.

FIG. 18 is a view of the ejector sleeves of the plastic injection mold of the present invention.

FIG. 19 is a view of the sprue extractor pin of the plastic injection mold of the present invention.

FIG. 20 is a view of the ejector retainer pins of the plastic injection mold of the present invention.

FIG. 21 is a view of the ejector backing plate of the plastic injection mold of the present invention.

FIG. 22 is a view of the forming pins of the plastic injection mold of the present invention.

FIG. 23 is a view of the support pillars of the plastic injection mold of the present invention.

FIG. 24 is a view of the ejection limit pins of the plastic injection mold of the present invention.

FIG. 25 is a view of the anchor support plate of the plastic injection mold of the present invention.

The terms “comprises,” “comprising,” “includes,” “including,” or any other variation thereof used herein are intended to cover a non-exclusive inclusion of the article, product, or device comprising a list of elements that does not include only those elements, but may include other elements not expressly listed.

Furthermore, the terms “a” and “an” herein do not denote a limitation of quantity but rather denote the presence of one or more of the elements or components referenced.

In particular, for simplicity and clarity of illustration, certain aspects of the figures represent the general structure and/or construction of the different embodiments. Descriptions and details of well-known features and techniques may be omitted to avoid confusion regarding other features.

Elements in the figures are not necessarily drawn to scale; the dimensions of some features may be exaggerated in relation to other elements to enhance understanding of the exemplary embodiments. Views are provided to help illustrate the various components of the assembly depicted and to show their location relative to each other.

In addition to the foregoing, the following definitions shall be considered in the present invention, unless otherwise indicated:

Plastic resin: These are synthetic chemical compounds used in the manufacture of various plastic products. They are obtained through polymerization processes and are classified into different types according to their properties.

Cold runner: Cold runner refers to the plastic injection system used in conventional molds, mostly with two and three plates, from which a plastic remnant or scrap is obtained.

Flow rate: In relation to water, flow rate refers to the amount of water circulating through a given location divided by unit of time.

Injection unit: It is a unit that pushes an injection plunger or screw forward inside a cylinder to inject molten plastic into the mold.

Barrel: This is part of the injection unit of the injection molding machine and it is where the plastic is melted, and contains the screw that transports the plastic from the hopper to the nozzle.

Nozzle: The nozzle is an element of the injection unit of the injection molding machine, installed at the end of the front end. This element transfers the molten material into the cavity through the mold sprue.

Injection cycle: This is the specific time required by the injection process to mold a plastic part from 0 to 100%.

Platen: The platens are fixed to the base of the injection molding machine, usually occupying the center of the base. They connect the injection unit on one side and the closing unit on the other.

In addition to the above, the term block when used herein should be understood as a compact piece and said term may or may not be used when referring to a plastic injection mold element, such as “cavity”, “core or internal part”. In this regard, the phrases “block of cavities” or “core block” should also be understood herein as “cavities” or “core” or vice versa, respectively, i.e. that such terms may be used interchangeably in this disclosure, unless otherwise indicated.

### DETAILED DESCRIPTION OF THE DISCLOSURE

The present invention relates to a plastic injection mold for the manufacture of a fluid-saving device. It is made up of or composed of two subassemblies identified herein as a fixed part (Side A) and a moving part (Side B) that when joined together form the mold, which, through the plastic injection process (polymers/plastic resin) through it, allows mass production of a fluid-saving device.

The injection system with which this mold was designed is called cold-runner, meaning the plastic resin (polymer or plastic) is melted in the barrel of the injection unit of the injection machine and injected into the mold through channels or conduits designed within the mold, which transport the molten plastic resin to the block of cavities or “cavity” of the mold. This mold design is called a two-plate (A and B) mold design. When coupled (or closed), these plates allow the molten plastic resin received in the mold cavities to be internally shaped into the desired design or product. For the ejection or removal of the molded plastic part, the mold has an ejection system comprising an ejector plate, an ejector backing plate, and ejector sleeves.

The plastic injection mold disclosed herein comprises the integration of mechanical elements that provide a significant change in the molded plastic part and in the manner of its manufacture. The change in the mold consists of mechanically connecting forming pins and an ejector sleeve to the internal block (core). The forming pins determine the internal diameter of the fluid-saving device, which also determines the resulting or desired flow rate. The new mold design allows the molded plastic part (fluid-saving device) to be manufactured without the need for a subsequent step, such as drilling the part after obtaining it or removing burrs, which are a defect in plastic parts.

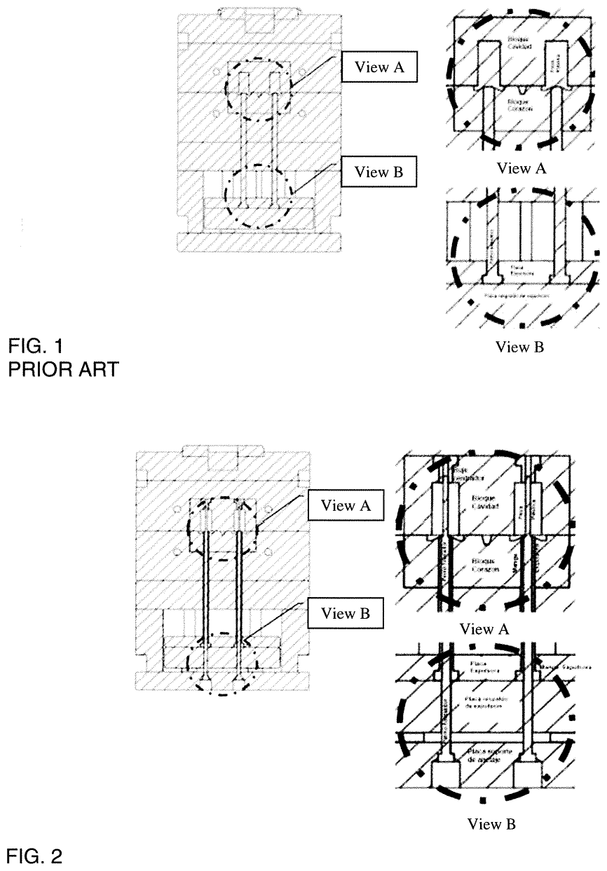

FIGS. 1 and 2 are self-explanatory because they are included here to demonstrate the differences between the prior-art mold and the new mold design. Therefore, we will turn our attention to the remaining figures.

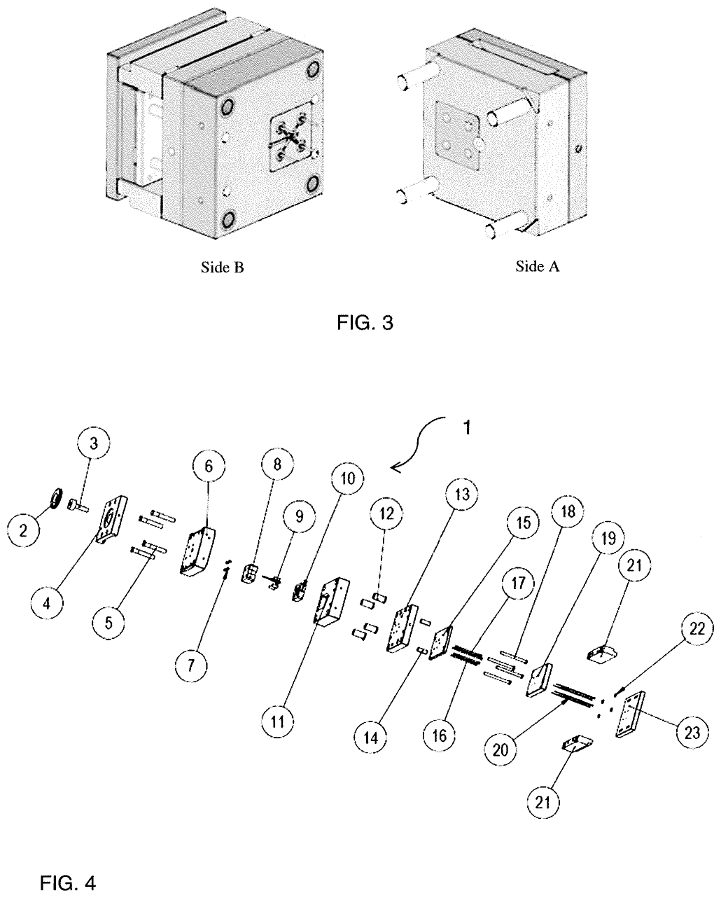

As shown in FIG. 3, the plastic injection mold (1) comprises two subassemblies, hereinafter referred to as the fixed part (or Side A) and the moving part (or Side B), which, when joined or assembled, form the mold. Each of the elements or parts of the plastic injection mold (1) has an assembly sequence, which is shown in detail in FIG. 4. For example, when assembling the cavity (8) and the internal part (core) 10 and injecting molten plastic through the injection mold (1) using the flow channel sprue (3), a rigid counter shape is obtained which results in the plastic part (fluid-saving device).

The mold consists of steel plates superimposed on one another, aligned and joined by fastening elements arranged between the plates, such as, without limitation, screws, bolts, etc. The main elements of the new mold model are the block of cavities (or cavity) (8), the core block or internal block (10), and the forming pins (20). See FIG. 4. The forming pins are interchangeable to achieve flexibility in product characteristics.

FIG. 4 shows in detail each of the components or elements that make up the injection mold (1), as well as their assembly location. It should be used as a reference during the description of each of the components or elements illustrated therein, even when not referenced, unless otherwise specified.

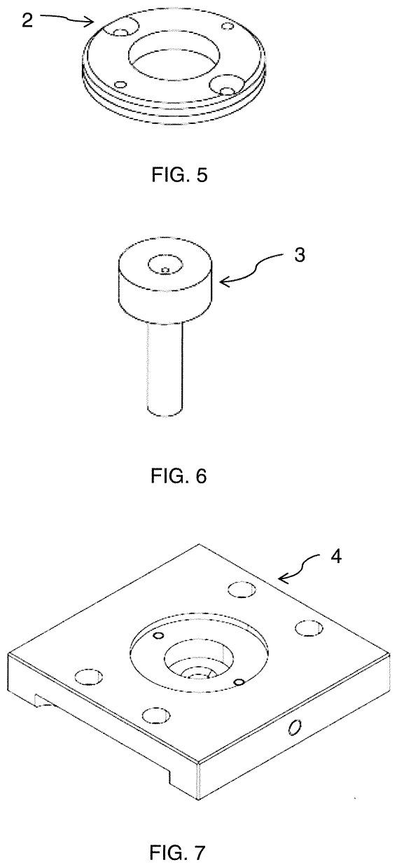

As shown in FIG. 4, the plastic injection mold (1) comprises a locating ring (2) located at the top of the mold, which is secured by fasteners, such as screws or bolts, to the backing plate (4) of the cavity holder plate (6) on side A (see FIG. 3) of the mold. The locating ring (2) allows the nozzle of the injection unit barrel (not shown) to be centered with a flow channel sprue (3) of the mold. As can be seen in FIG. 5, the locating ring (2) has four holes, two of which are countersunk so that the screw or bolt used for its assembly does not protrude.

According to FIG. 4, the flow channel sprue (3) of the injection mold (1) engages the locating ring (2). As can be seen in FIG. 6, the flow channel sprue (3) has a central hole through which the resin is injected into the mold for manufacturing the plastic part. The diameter of the upper part (head) of the flow channel sprue (3) is greater than the diameter of its lower part (stem).

The plastic injection mold comprises a cavity backing plate (4) to which the flow channel sprue (3) is also assembled at its lower part or stem, as shown in FIG. 4. The cavity backing plate (4) is fixed or clamped to the cavity holder plate (6) so that the half of the mold of the fixed part (Side A) can be attached to the injection machine platen (not shown). Both the flow channel sprue (3) and the locating ring (2) are fixed to this same cavity holder plate (6). As shown in FIG. 7, the cavity backing plate (4) has four holes through which guide pins (5) pass, allowing alignment and assembly with other elements of the injection mold (1).

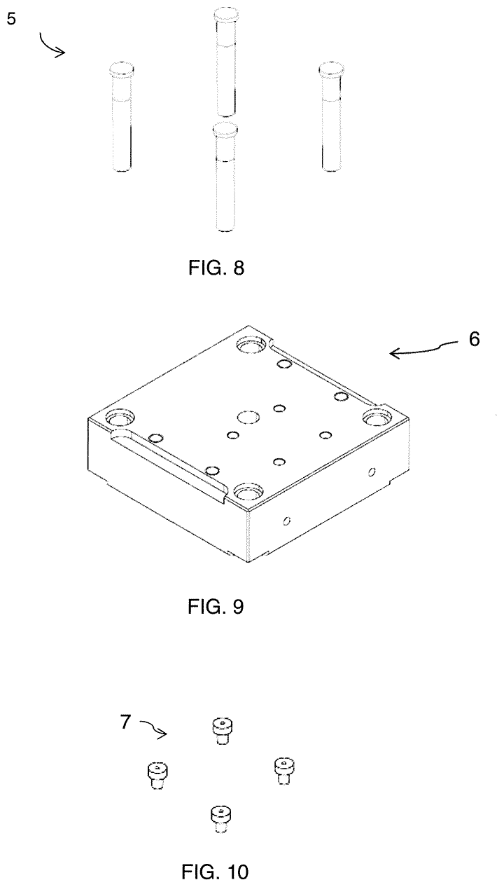

The guide pins (5) (see FIG. 8) allow the assembly and alignment of the cavity backing plate (4) and the cavity holder plate (6) (Side A). They also ensure that when the plastic injection mold (1) is closed by joining sides A and B, these sides are aligned, causing the plastic injection mold (1) to close correctly and tightly, avoiding misalignments between the cavity (8) and the internal block or core (10), which could cause misalignment defects in the plastic parts produced and damage to the mold.

In FIG. 4, the cavity holder plate (6) is a block with perforations that supports the block of cavities. This plate remains assembled to the cavity backing plate (4) and on which also assembles the flow channel sprue (3) that distributes the molten plastic resin to the channels or conduits of the injection mold (1) and finally to the cavities. The cavity holder plate has 4 holes, one in each of its corners through which the guide pins (5) pass that will help its alignment and assembly with other elements of the mold and it also has two recesses, one on each side of it (see FIG. 9). These recesses help when the mold is disassembled.

In FIG. 4, the centering bushings (7) of FIG. 10 are drilled in the center to receive or house the forming pins (20) of FIG. 18, causing their alignment within the cavity (8) of FIG. 11, causing the hermetic and correct sealing of said elements to form the central figure or design of the hole of the plastic part.

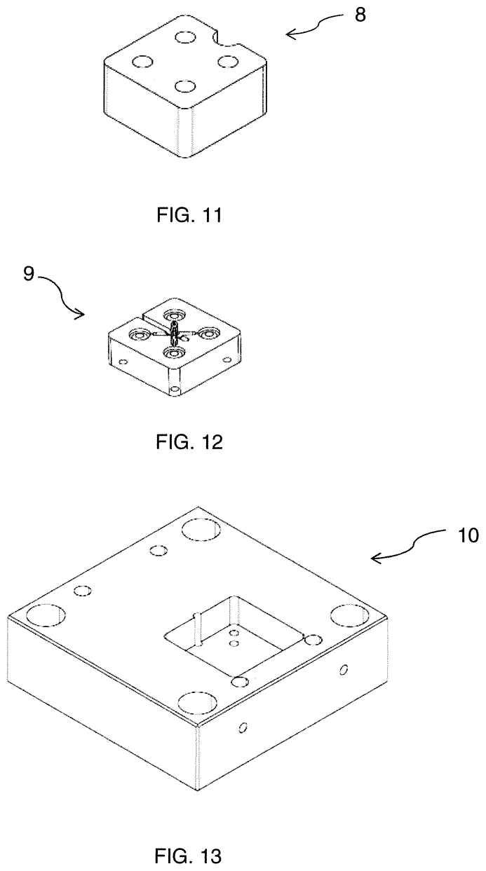

In accordance with FIG. 4, the cavity (8) of FIG. 11 is a block of cavities that has a great impact on the final plastic part since it is where the external geometry of the final product (9) is defined. Said block of cavities (8) is the receiver of the flow of molten plastic resin, which fills the gaps or voids remaining when Side A and Side B of the injection mold (1) are coupled or closed. The cavities are coupled with the core block (10) of FIG. 12 and the forming pins (20) of FIG. 18 to form the final product(s) (9) with the required design specifications.

The core block (10) of FIG. 12 is the complement of the block of cavities (8). Said core block (10) defines a part of the internal geometry of the plastic part. The core block (10) contains the channels or conduits through which the molten plastic resin flows and, through the cavity gates, fills the remaining spaces or voids resulting from the assembly of the block of cavities (8), core block (10), and fixed forming pins (20) to produce the final fluid-saving device or plastic part.

FIG. 13 shows the movable core backing plate (13) that holds or retains the core block (10) and serves as a support for the block of cavities. The movable core backing plate (13) has 4 holes, each located in each corner of the plate, through which the guide pins (5) pass, aligning it, facilitating its assembly with the movable core backing plate (13).

The guide bushings (14) in the figure, also shown in FIG. 4, play a very important role in the assembly and alignment of the injection mold (1). They generally assist in the alignment and assembly of the core holder plate (11) and the core backing plate (13). In particular, the guide bushings (12), in interaction with the guide pins, are the elements that align the plastic injection mold (1) when it is closed (sides A and B are coupled) to begin the plastic resin injection cycle from the molding machine (not shown). This alignment is imperative as it will prevent possible damage to the injection mold (1) and, more importantly, defects, malformations, and damage to the molded plastic part.

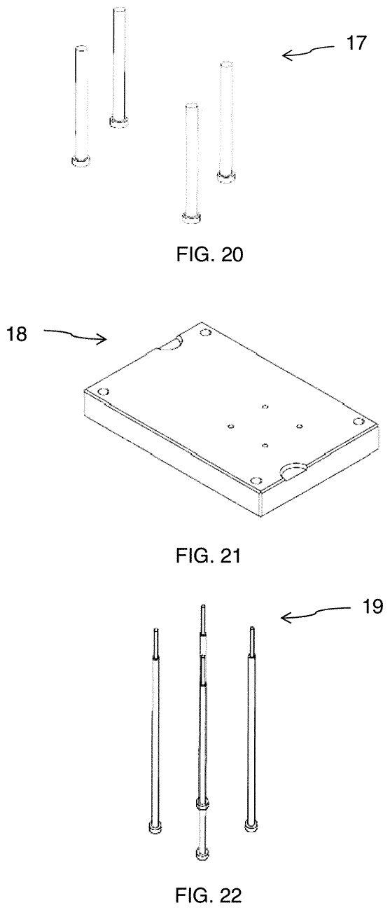

The ejector plate (15) in FIG. 15, also shown in FIG. 4, has a series of holes to secure or hold the ejector sleeves (16) in FIG. 15 and the ejector retaining pins (18) shown in FIG. 20, which together constitute the mold ejection system.

According to FIG. 4, the plastic injection mold (1) has ejector sleeves (16) shown in FIG. 16, which release the molded plastic part from the forming pins (20) and eject the finished product(s) from the mold once the plastic injection mold (1) completes the injection cycle and separates into its two parts.

The sprue extractor pin (17) in FIG. 19 holds or clamps the molded plastic part from the sprue and separates the part from the fixed part (Side A) when the mold opens and until the ejector sleeves (16) eject the plastic part(s) from the mold.

The ejector retainer pins (18) in FIG. 20 limit the travel of the ejector sleeves (16) so that they only have to travel the course necessary to eject the plastic part. As seen in FIG. 4, the ejector retainer pins (18) are assembled with the ejector plate (15), the ejector backing plate (19), the ejector sleeves (16), which together form an ejection system, and the sprue extractor pin through the different holes in the plates.

As mentioned above, the ejector backing plate (19) shown in FIG. 21 is part of the ejection system that makes up the mold. The ejector backing plate (19) has 4 holes or bores, each located in each corner of the ejector backing plate (19), and 2 notches or recesses, each located at the narrowest part of the plate, one on the left side and one on the right side, to assist in mold disassembly. In addition, as shown in FIG. 19, the ejector backing plate (19) also has 4 additional smaller diameter holes or bores, located symmetrically with respect to each other on the surface of the ejector backing plate (19), to accommodate the ejector sleeves (16). The 4 larger diameter holes or bores allow the ejector backing plate (19) to be assembled together with the ejector retainer bolts (18) and the ejecting or ejector sleeves (16), in addition to supporting the ejector plate (15).

FIG. 22 shows the fixed forming pins (20) used to form the orifice of the plastic part or fluid-saving device (not shown); their role is to provide the geometry of the central orifice of the internal body of the plastic part or fluid-saving device. These pins are complementary to the block of cavities (8) and the core (10). One skilled in the art will understand that these fixed forming pins (20) can be replaced with others with different diameter specifications for the manufacture of different plastic parts with different flow requirements.

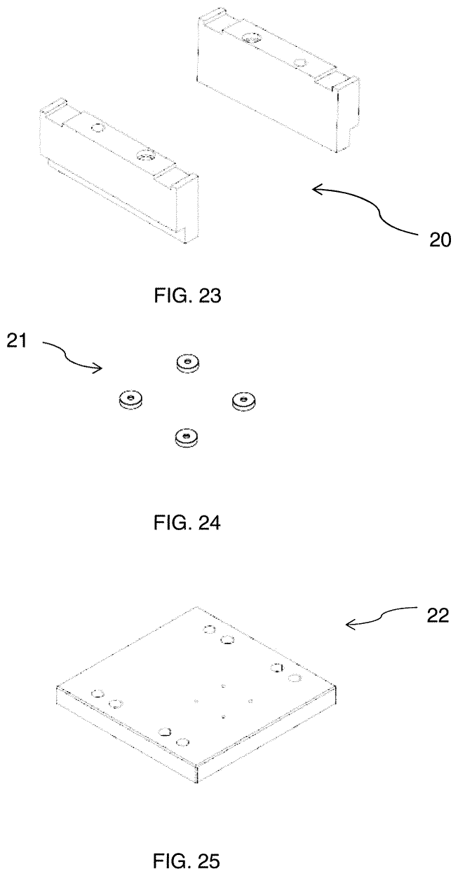

The support pillars (21) shown in FIG. 23 generate a space or gap through which the ejection system, comprising the ejector plate (15), the ejector backing plate (19), and the ejector sleeves (16), moves forward, causing the ejector sleeves (16) to be pushed forward, protruding from the core plate (10), and further ejecting the plastic part(s). The support pillars (21) also allow for backward movement to prepare the mold to begin the cycle of a new injection of the plastic resin (or plastic).

As shown in FIG. 23, the support pillars (21) have recesses on their upper surface on each side to allow for the coupling or adjustment of the ejector backing plate (19), two holes or bores, a recess on their lower part from side to side, that is, along each support pillar, which are used to anchor or fix the mold to the injection machine platen, and two holes on both their right and left sides.

As shown in FIG. 24, the plastic injection mold (1) has ejection limiting pins (22) which prevent or limit contact between the ejection backing plate (19) and the anchor support plate (23) shown in FIG. 25, thus avoiding detrimental damage to the mold. To allow the assembly of said pins with the other elements or parts of the mold, each one is drilled in its center.

The anchor support plate (23) shown in FIG. 25, supports the weight of the moving side of the mold (Side B) and allows the assembly of the mold to the platen of the injection machine. The anchor support plate (23) located on the moving side (Side B) has a series of holes or bores of different diameters distributed on its upper surface, to allow its assembly to the support pillars (21) and to the ejection backing plate (19).

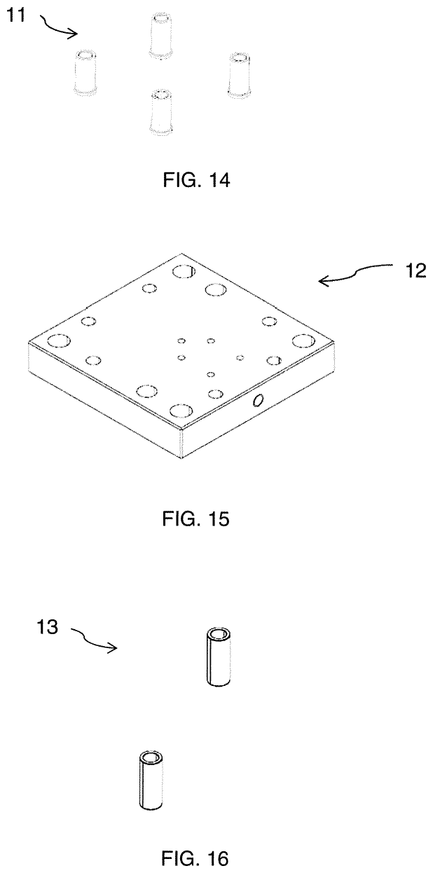

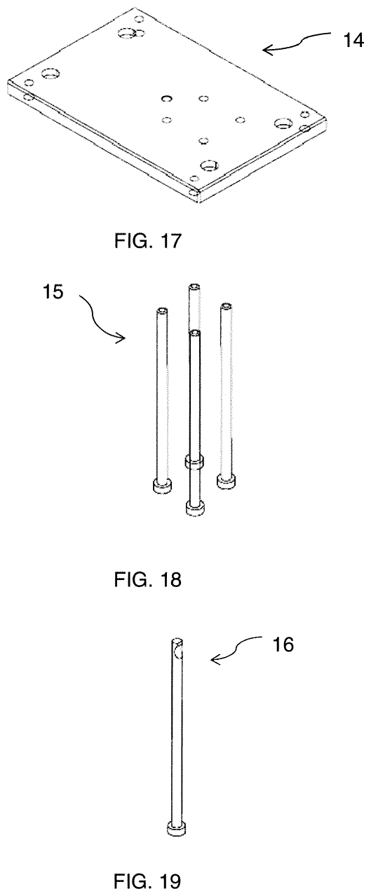

Embodiments of the invention are described herein, which should in no way be construed as limiting, but rather should be interpreted as illustrative, exemplifying the principles thereof. Any section headings used herein are for organizational purposes only and should not be construed as limiting the subject matter described. For the purposes of this disclosure, all component/structural element/part or operating assembly identification numbers can be found in FIGS. 1 through 25 unless otherwise indicated.

The present invention is not limited in scope by the specific embodiments described herein. In fact, various modifications of the invention in addition to those described herein will be apparent to those skilled in the art from the aforementioned description. Such modifications are intended to fall within the scope of the appended claims.

1. A plastic injection mold for manufacturing a fluid-saving device, comprising:
a fixed part and a movable part;
a locating ring having a central hole mounted and screwed onto a cavity backing plate to center a nozzle of the barrel of an injection unit with a flow channel sprue of the mold;
wherein the cavity backing plate is a support for securing or holding a cavity holder plate and for the fixed part of the mold to be secured or held to the platen of the injection unit;
guide pins located between the cavity backing plate and the cavity holder plate, the guide pins being inserted or coupled into the cavity holder plate, aligning the backing plate, allowing the cavity backing plate to couple with the flow channel sprue;
centering bushings to allow the same number of forming pins to align and seal the fixed part and moveable part of the mold;
a block of cavities is connected to the cavity holder plate by means of the centering bushings;
a core that engages with a core holder plate, where the core holder plate is movable and houses the core and a block of cavities;
guide bushings for aligning and assembling the core holder plate and the cavity backing plate,
wherein the cavity backing plate is fixed to the core holder plate so that it is secured to the injection unit platen;
aligning pins to align all the elements that make up the mold during its assembly;
an ejection system that ejects the plastic part;
a sprue extractor pin that engages with an ejector plate and an ejector backing plate and separates the plastic part from the fixed side when the mold is opened;
ejector retainer pins that engage with the ejector plate and the ejector backing plate and limit the stroke of the ejector sleeves;
forming pins that engage with the ejector backing plate and are part of the block of cavities and core;
support pillars that are placed or coupled between the backing plate and an anchor support plate to allow the ejection system to move forward,
wherein the anchor support plate holds or secures the plastic injection mold half to the injection unit; and,
ejection limiting bolts that are mounted on the anchor support plate.

2. The plastic injection mold according to claim 1, wherein the ejection system comprises the ejector plate, the ejector backing plate, and the ejector sleeves.

3. The plastic injection mold according to claim 1, wherein the block of cavities has four holes or orifices, each located at a predetermined distance from each of its corners, and a recess or notch on one of its sides.

4. The plastic injection mold according to claim 1, wherein the core is mounted or located on the upper surface of the movable core-holder plate.

5. The plastic injection mold according to claim 1, wherein the fixed forming pins are coupled to the cavity through the holes therein.

6. The plastic injection mold according to claim 1, wherein the core comprises channels or conduits through which the molten plastic resin flows.
